(19) United States
(12) Patent Application Publication
(10) Pub. No.: US 2003/0103772 A1
(43) Pub. Date: Jun. 5, 2003

(54) Optical transmitter and optical transmission system

(76) Inventors: Yoshikazu Ishii, Yokohama-shi (JP); Katsuya Oda, Yokohama-shi (JP); Masato Tanaka, Sagamihara-shi (JP); Hiroaki Asano, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/290,271

(22) Filed: Nov. 8, 2002

(30) Foreign Application Priority Data
Nov. 30, 2001 (JP) 2001-367589

(51) Int. Cl. H04B 10/04

(52) U.S. Cl. 398/197; 398/33; 398/32; 398/26

(57) ABSTRACT

In an optical transmitter comprising a laser module including a laser diode and a monitor photodiode, a laser drive circuit for supplying a drive current to the laser module and an APC circuit for applying a bias current to the laser module on the basis of a detection signal from the monitor photodiode so that the output level of the laser module becomes constant, there is further provided an extinction ratio control circuit including an RF signal generating circuit, a low-pass filter and a peak detecting circuit. The extinction ratio control circuit superimposes an RF signal on an input data signal to the laser drive circuit to control the amplification degree of the laser drive circuit on the basis of the RF signal of the detection signal from the monitor photodiode so that the extinction ratio of the output light from the laser module becomes constant. This enables controlling the extinction ratio of the output light of the laser module without employing a high-priced high-response photodiode even in a case in which the data signal is transmitted at a high speed.

### BACKGROUND OF THE INVENTION

1) Field of the Invention

The present invention relates to an optical transmitter and an optical transmission system using this optical transmitter, and more particularly to an optical transmitter and optical transmission system, capable of maintaining a laser module at an appropriate luminescence quantity and at an appropriate extinction ratio even if the variation in environmental temperature and aged deterioration have occurred.

2) Description of the Related Art

So far, as an optical transmitter having an extinction ratio control function, there has been known a transmitter disclosed in Japanese Unexamined Patent publication No. SHO 58-104536. FIG. 12 is a block diagram showing an example of a conventional configuration of an optical transmitter having an extinction ratio control function, where portions unrelated to the invention are omitted from the illustration. In FIG. 12, an optical transmitter 34 is made up of a laser drive circuit 3 for receiving a data signal to supply a drive current to a laser module, an adding unit 4 for adding a laser driving bias current to an output of the laser drive circuit 3, a laser module 7 including a laser diode 5 for producing an optical output on the basis of an output of the adding unit 4 and a monitor photodiode 6 for monitoring the optical output thereof, an APC (Automatic Power Control) circuit 8 for controlling a bias current to be supplied to the laser diode 5 on the basis of a DC (Direct Current) component from the laser module 7 so that the laser diode 5 develops a constant luminescence quantity, a DC cutoff capacitor 33 for cutting off a DC component from an output of the laser module 7, and a peak detecting circuit 10 for detecting a level of a detected data signal coming from monitor photodiode 6 through the DC cutoff capacitor 33 to maintain an extinction ratio of an output of the laser module 7 at a predetermined value by controlling an amplification degree of the laser drive circuit 3 so that the detected level is maintained at a predetermined value.

Secondly, a description will be given hereinbelow of an operation of the conventional optical transmitter 34 having the above-mentioned configuration.

A data signal inputted to the optical transmitter 34 enters the laser drive circuit 3 to undergo amplification. To the data signal amplified thereby, there is added a laser driving bias current from the APC circuit 8, with the bias current added data signal being applied to the laser diode 5. An output of the laser diode 5 is detected by the monitor photodiode 6 and a DC component thereof is given to the APC circuit 8 for controlling the bias current to be supplied to the laser diode 5 so that the laser diode 5 develops a constant luminescence quantity. Meanwhile, the data signal detected by the monitor photodiode 6 is fed through the DC cutoff capacitor 33 to the peak detection circuit 10 for detecting a peak level thereof so that the amplification degree of the laser drive circuit 3 is controlled to maintain the detected level of the data signal, thus maintaining the extinction ratio of the output of the laser module 7 at a predetermined value.

However, in the case of the above-described configuration of the conventional optical transmitter 34, if the data signal is transmitted at high speed, the photodiode 6, which monitors the output light of the laser module, is required to have a fast response characteristic enough for the reception of the high-speed data.

### SUMMARY OF THE INVENTION

The present invention has been developed in consideration of this problem, and it is therefore an object of the invention to provide an optical transmitter and optical transmission system capable of controlling the extinction rate without using a high-priced photodiode having a fast response function even if a data signal is transmitted at high speed.

For this purpose, in accordance with the present invention, there is provided an optical transmitter comprising a laser module including a laser diode and a monitor photodiode for monitoring an optical output of the laser diode, a laser drive circuit for supplying a drive current to the laser module, an automatic output control circuit for supplying a bias current to the laser module on the basis of a detection signal from the monitor photodiode so that the laser module produces a constant output level, and an extinction ratio control circuit for applying an RF (Radio Frequency) signal to an input data signal to the laser drive circuit in a superimposed condition to control an amplification degree of the laser drive circuit on the basis of the superimposed RF signal of the detection signal from the monitor photodiode so that an output light of the laser module has a constant extinction ratio.

With this arrangement, even when the transmission of a data signal is made at high speed, without employing a high-priced fast-response photodiode, an RF signal superimposed on the data signal is detected by the monitor photodiode for controlling the extinction ratio of the output light of the laser module to a constant value on the basis of the detection signal therefrom.

In addition, the extinction ratio control circuit uses, as the RF signal to be superimposed thereon, an RF signal having a low frequency which is preventable from superimposition on a spectrum of the data signal, and the laser drive circuit is designed to be capable of exhibiting a low-frequency amplification function to cover the low-frequency RF signal to be superimposed thereon. This arrangement can separate spectrally the RF signal superimposed from the data signal, and the laser drive circuit amplifies both the data signal and low-frequency RF signal superimposed thereon.

Still additionally, the extinction ratio control circuit superimposes, as the RF signal to be superimposed on the data signal, a signal amplitude-modulated, and amplitude-demodulates, of the detection signal from the monitor photodiode, the amplitude-modulated RF signal to control the amplification degree of the laser drive circuit on the basis of the demodulated signal so that the output light from the laser module has a constant extinction ratio. With this arrangement, the amplitude-modulated RF signal superimposed on the data signal is detected by the monitor photodiode to control the extinction ratio of the output light of the laser module to a constant value through the use of a signal obtained by amplitude-demodulating the detection signal.

Yet additionally, the extinction ratio control circuit superimposes, as the amplitude-modulated RF signal to be superimposed on the data signal, an amplitude-modulated RF signal with a low frequency enough to avoid complete burying in a spectrum of the data signal, and the laser drive circuit is designed to have a low-frequency amplification function to cover the amplitude-modulated low-frequency RF signal to be superimposed thereon. With this arrangement, the amplitude-modulated RF signal to be superimposed thereon is detectable without being completely buried in the spectrum of the data signal. The laser drive circuit amplifies both the data signal and amplitude-modulated low-frequency RF signal to be superimposed thereon.

Moreover, the extinction ratio control circuit superimposes, as the RF signal to be superimposed on the data signal, an RF signal with a level to which a degradation of an EYE aperture (opening degree) of an output light from the laser module does not occur due to the superimposition of the RF signal. With this arrangement, the adjustment of the superimposition level of the RF signal prevents the degradation of the EYE aperture of the output light.

Furthermore, in accordance with the present invention, an optical transmission system comprises the above-described optical transmitter and an optical receiver for receiving an optical signal from the optical transmitter, and at the previous stage of a discriminating unit for regeneration of the data signal, the optical receiver is equipped with a high-pass filter for cutting off the superimposed RF signal from the optical signal. With this configuration, the high-pass filter contained in the optical receiver removes the RF signal superimposed before the discriminating unit.

In addition, an optical fiber amplifier is provided which is connected to an optical output terminal of the laser module for leading out an optical output, and the extinction ratio control circuit superimposes, as the RF signal to be superimposed on an input data signal to the laser drive circuit, an RF signal with a low frequency lower than a low cutoff frequency of the optical fiber amplifier and supplies it to the laser drive circuit for controlling the amplification degree of the laser drive circuit on the basis of the superimposed RF signal of the detection signal from the monitor photodiode so that the output light of the laser module has a constant extinction ratio. With this configuration, the RF signal superimposed on the data signal is detected by the monitor photodiode to control the extinction ratio of the output light of the laser diode through the use of the detection signal, and the optical fiber amplifier connected to the output of the laser module cuts off the RF signal superimposed on the data signal prior to the transmission.

Still additionally, the extinction ratio control circuit superimposes, as the RF signal to be superimposed on the data signal, an RF signal with a low frequency lower than a low cutoff frequency of the optical fiber amplifier and enough to avoid overlapping with a spectrum of the data signal, and the laser drive circuit is designed to have a low-frequency amplification function to cover the low-frequency RF signal to be superimposed thereon. This configuration enables the spectral separation between the RF signal superimposed and the data signal, and the laser drive circuit amplifies both the data signal and the low-frequency RF signal superimposed thereon.

Yet additionally, the extinction ratio control circuit superimposes, as the RF signal to be superimposed on the data signal, a signal amplitude-modulated, and amplitude-demodulates, of the detection signal from the monitor photodiode, the amplitude-modulated RF signal to control the amplification degree of the laser drive circuit on the basis of the demodulated signal so that the output light from the laser module has a constant extinction ratio. With this arrangement, the amplitude-modulated RF signal superimposed on the data signal is detected by the monitor photodiode to control the extinction ratio of the output light of the laser module to a constant value through the use of a signal obtained by amplitude-demodulating the detection signal.

Moreover, the extinction ratio control circuit superimposes, as the amplitude-modulated RF signal to be superimposed thereon, a signal with a low frequency lower than a low cutoff frequency of the optical fiber amplifier and enough to avoid complete burying in a spectrum of the data signal, and the laser drive circuit is designed to be capable of exhibiting a low-frequency amplification function to cover the low-frequency amplitude-modulated RF signal to be superimposed thereon. With this configuration, the amplitude-modulated RF signal to be superimposed thereon is detectable without being completely buried in the spectrum of the data signal. The laser drive circuit amplifies both the data signal and amplitude-modulated low-frequency RF signal to be superimposed thereon.

Still furthermore, in accordance with the present invention, there is provided an optical transmission system comprising the above-described optical transmitter including the optical fiber amplifier and an optical receiver for receiving an optical signal from the optical transmitter. In this configuration, the optical fiber amplifier connected to the laser module cuts off the RF signal.

### BRIEF DESCRIPTION OF THE DRAWINGS

Other objects and features of the present invention will become more readily apparent from the following detailed description of the preferred embodiments taken in conjunction with the accompanying drawings in which:

FIG. 1 is a block diagram showing a configuration of an optical transmitter according to a first embodiment of the present invention;

FIG. 2 is an illustration of a characteristic of a low-pass filter (LPF) for use in the optical transmitter according to the first embodiment of the present invention;

FIG. 3 is a block diagram showing a configuration of an optical transmitter according to a second embodiment of the present invention;

FIG. 4 is an illustration of the relationship between amplitude-modulated RF signal and a data signal in the optical transmitter according to the second embodiment of the present invention;

FIG. 5 is an illustration of one example of the relationship between RF superimposition levels and EYE apertures of output light waveforms of an optical transmitter according to a third embodiment of the present invention;

FIG. 6 is a block diagram showing a configuration of an optical transmission system according to a fourth embodiment of the present invention;

FIG. 7 is an illustration of a characteristic of a high-pass filter (HPF) for use in an optical transmitter of the optical transmission system according to the fourth embodiment of the present invention;

FIG. 8 is a block diagram showing a configuration of an optical transmitter according to a fifth embodiment of the present invention;

FIG. 9 is an illustration of a frequency response characteristic of an optical fiber amplifier for use in the optical transmitter according to the fifth embodiment of the present invention;

FIG. 10 is a block diagram showing a configuration of an optical transmitter according to a sixth embodiment of the present invention;

FIG. 11 is a block diagram showing a configuration of an optical transmission system according to a seventh embodiment of the present invention; and

FIG. 12 is a block diagram showing a configuration of a conventional optical transmitter.

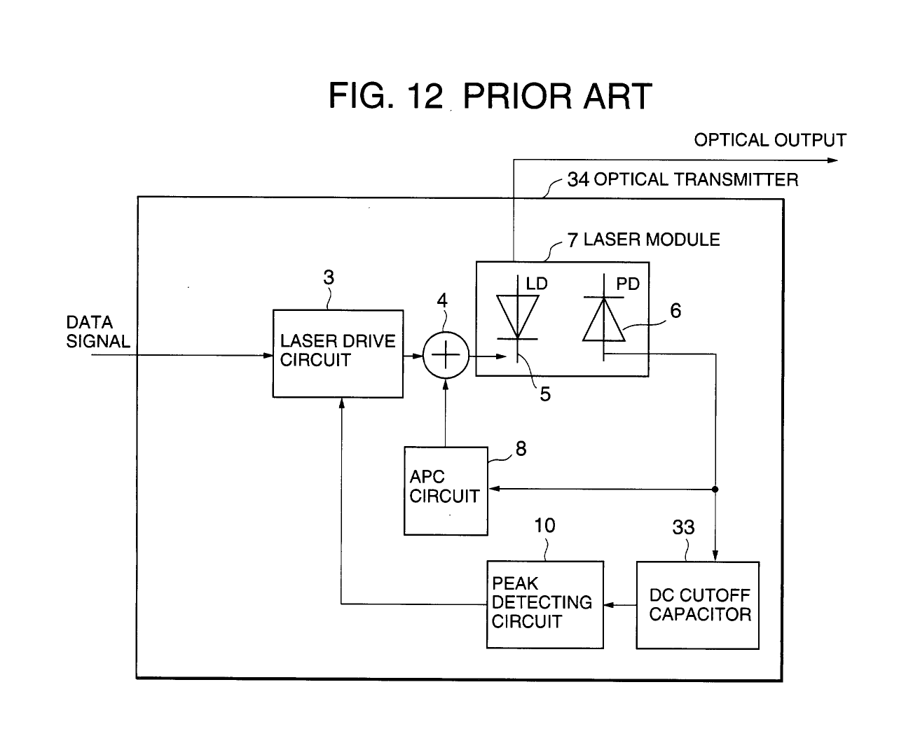

### DESCRIPTION OF THE PREFERRED EMBODIMENTS

Embodiments of the present invention will be described hereinbelow with reference to the drawings. In the following description, the same/corresponding parts as/to those of the above-mentioned conventional example are marked with the same reference numerals.

(First Embodiment)

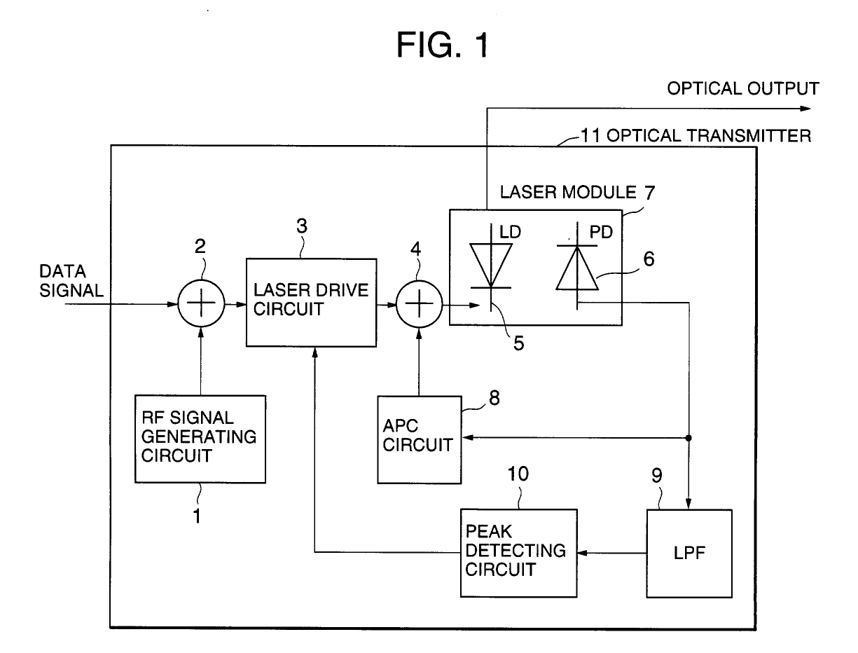

FIG. 1 is a block diagram showing a configuration of an optical transmitter according to a first embodiment of the present invention.

In FIG. 1, in addition to a laser drive circuit 3, an adding unit 4, a laser module 7 and an APC circuit 8 which are similar to those of the conventional example, an optical transmitter 11 according to the first embodiment includes, as an extinction ratio control circuit for controlling an amplification degree of the laser drive circuit 3 so that the extinction ratio of an output light of the laser module 7 becomes constant, an RF signal generating circuit 1 for superimposing an RF (Radio Frequency) signal on an input data signal to the laser drive circuit 3, a low-pass filter (LPF) 9 for separating an RF signal from an output of a monitor photodiode 6, and a peak detecting circuit 10 for detecting a peak level of the RF signal separated by the LPF 9 to control an amplification degree of the laser drive circuit 3 so that the detected level is maintained at a predetermined value. Moreover, in this optical transmitter 11, there is provided an adder unit 2.

Secondly, a description will be given hereinbelow of an operation of the optical transmitter according to the first embodiment shown in FIG. 1.

A data signal inputted to the optical transmitter 11 is coupled (multiplexed) with an RF (Radio Frequency) signal, produced by the RF signal generating circuit 1, in an adding unit 2 and then fed to the laser drive circuit 3 to amplify both the data signal and RF signal superimposed thereon. A bias current for laser drive from the APC circuit 8 is added to the amplified data signal and RF signal, and supplied to the laser diode 5. An output of the laser diode 5 is detected by the monitor photodiode 6 and the DC component thereof is given to the APC circuit 8 for controlling the bias current, to be supplied to the laser diode 5, so that the laser diode 5 produces a constant luminescence quantity.

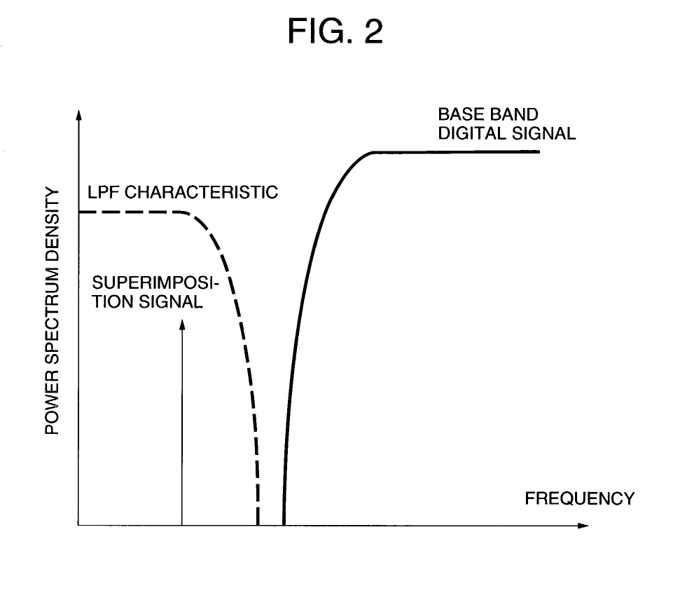

On the other hand, the superimposed RF signal detected by the monitor photodiode 6 is separated from the data signal through the LPF 9. In this case, the frequency of the superimposed RF signal is set to be low enough to separate from the spectrum of the data signal (baseband digital signal) as shown in FIG. 2, and the laser drive circuit 3 is designed to have a low-frequency amplification function capable of achieving the amplification in a range from a low frequency, covering even the superimposed low-frequency RF signal, thus sufficiently reducing the leakage of the spectrum of the data signal into the RF signal. The RF signal separated in the LPF 9 is fed to the peak detecting circuit 10 to detect a peak level thereof so that the amplification degree of the laser drive circuit 3 is controlled to maintain this detection level at a predetermined value, thereby maintaining the extinction ratio of the output of the laser module 7 at a predetermined value.

As described above, according to the first embodiment, an RF signal with a low frequency is superimposed on a data signal and an amplification degree of the laser drive circuit is controlled on the basis of as level of the RF signal detected by the monitor photodiode for controlling the extinction ratio of the output light of the laser drive circuit. Therefore, in a case in which the data signal is also required to be transmitted at a high speed, even a low-priced monitor photodiode packaged in a laser module becomes useful to control the extinction ratio, which eliminates the need for the employment of a high-priced fast-response photodiode for the reception of fast data. In addition, since the frequency of the RF signal to be superimposed on the data signal is set to be low enough to separate from the spectrum of the data signal, it is possible to reduce the leakage of the digital signal spectrum of the output of the monitor photodiode into the RF signal, which allows the extinction ratio control with high sensitivity. Still additionally, since the RF signal to be superimposed is put on the data signal at the former stage of the laser drive circuit and then enters the laser drive circuit, it is possible to prevent the extinction ratio variation of the output light not only due to the temperature variation and aged deterioration of the laser diode but also stemming from the temperature variation and aged deterioration of the laser drive circuit, which enables the control of the extinction ratio to a predetermined value.

(Second Embodiment)

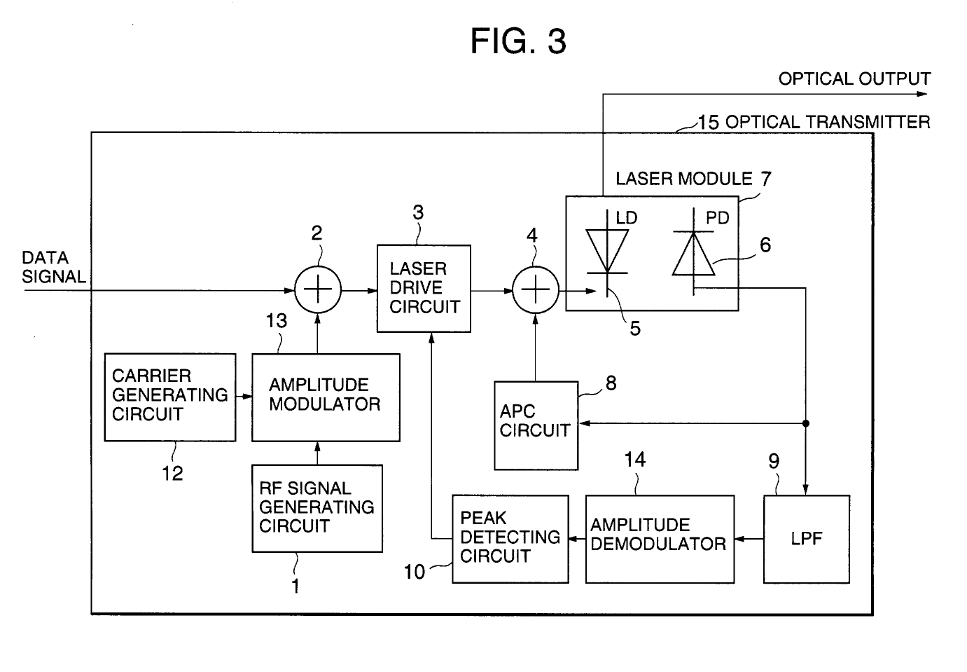

FIG. 3 is a block diagram showing a configuration of an optical transmitter according to a second embodiment of the present invention. In FIG. 3, in addition to the adding unit 2, the laser drive circuit 3, the adding unit 4, the laser module 7 and the APC circuit 8 which are similar to those of the above-described first embodiment shown in FIG. 1, an optical transmitter 15 according to the second embodiment includes, as an extinction ratio control circuit, an RF signal generating circuit 1, a carrier generating circuit 12, an amplitude modulator (amplitude modulating (AM) unit) 13 for supplying an RF signal, amplitude-modulated (AM-modulated) on the basis of the outputs of the RF signal generating circuit 1 and the carrier generating circuit 12, to the adding unit 2 to superimpose the RF signal on a data signal, an LPF 9, an amplitude demodulator (amplitude-modulated signal demodulating unit) 14 for amplitude-demodulating (AM-demodulating) the amplitude-modulated RF signal of the output of the LPF 9, and a peak detecting circuit 10 for controlling the amplification degree of the laser drive circuit on the basis of the demodulated signal from the amplitude demodulator 14.

Secondly, a description will be given hereinbelow of an operation of the optical transmitter according to the second embodiment.

In the amplitude modulator 13, an RF signal produced by the RF signal generating circuit 1 is amplitude-modulated through the use of a carrier signal from the carrier generating circuit 12, and in the adding unit 2, the amplitude-modulated RF signal is then joined with (superimposed on) a data signal inputted to the optical transmitter 15. This superimposition signal (the RF signal+the data signal) is given to the laser drive circuit 3 to amplify both the data signal and superimposed amplitude-modulated RF signal. A bias current for laser driving from the APC circuit 8 is added to the amplified data signal and RF signal and the resultant signal is supplied to the laser diode 5. The output of the laser diode 5 is detected by the monitor photodiode 6, and the DC component thereof is given to the APC circuit 8 to control the bias current to be supplied to the laser diode 5 so that the laser diode 5 produces a constant luminescence quantity.

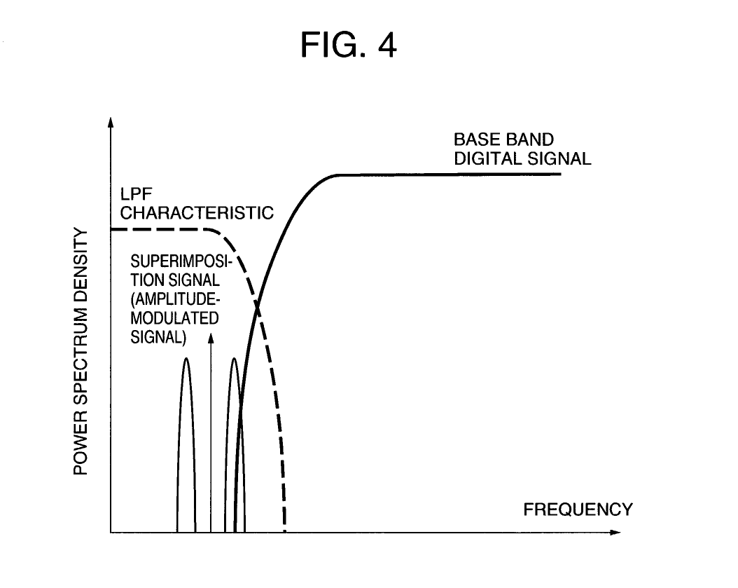

On the other hand, the superimposed RF signal detected by the monitor photodiode 6 is separated from the data signal through the LPF 9. The RF signal separated by the LPF 9 is demodulated in the amplitude demodulator 14 and a peak level thereof is detected by the peak detecting circuit 10. The amplification degree of the laser drive circuit 3 is controlled to maintain the detection level at a predetermined value, thereby keeping the extinction ratio of the output of the laser module 7 at a predetermined value. In this case, in addition to the function to amplitude-modulate the RF signal, the frequency of the amplitude-modulated RF signal to be superimposed on the data signal is set to be low enough to avoid the full burying in the spectrum of the data signal, and the laser drive circuit 3 is designed to have a low-frequency amplification function capable of achieving the amplification in a range from a low frequency, covering even the amplitude-modulated low-frequency RF signal to be superimposed thereon. As FIG. 4 shows, even in a case in which the leakage of the spectrum of the data signal into the superimposed RF signal occurs slightly, this arrangement can enhance the strength or resistance against the leakage owing to the amplitude demodulation, thus improving the accuracy of the extinction ratio control.

As described above, according to the second embodiment, a low-frequency RF signal is superimposed on a data signal and the amplification degree of the laser drive circuit is controlled on the basis of a level of the RF signal detected by the monitor photodiode to control the extinction ratio of the output light. Therefore, even in a case in which the data signal is transmitted at a high speed, this arrangement permits the extinction ratio control through the use of a low-priced monitor photodiode generally packaged in a laser module, and eliminates the need for the employment of a high-priced high-response photodiode capable of receiving fast data. In addition, since the RF signal to be superimposed is put on the data signal at the former stage of the laser drive circuit to be passed through the laser drive circuit, it is possible to prevent the extinction ratio variation of the output light not only due to the temperature variation and aged deterioration of the laser diode but also stemming from the temperature variation and aged deterioration of the laser drive circuit, which enables the control of the extinction ratio to a predetermined value. Still additionally, the employment of the function to amplitude-modulate the RF signal to be superimposed on the data signal improves the strength and resistance against the leakage of the spectrum of the data signal, thus enhancing the accuracy of the extinction ratio control.

(Third Embodiment)

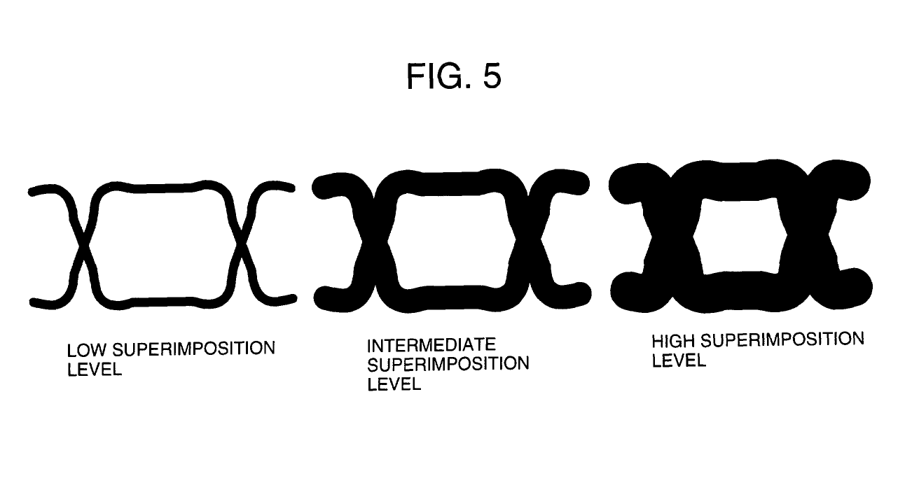

An optical transmitter according to a third embodiment of the present invention is designed to includes, in the above-described configuration according to the first or second embodiment, a function to adjust the level of an RF signal to be superimposed on a data signal to a level which does not cause the deterioration of an EYE aperture of a transmission waveform and the characteristic degradation at the 3R regeneration after the transmission. FIG. 5 is an illustration of the relationship between a superimposition level of an RF signal and an EYE pattern of a transmission waveform. As FIG. 5 shows, the EYE aperture deteriorates as the superimposition level increases, thereby causing the characteristic degradation at the 3R regeneration after the transmission. Accordingly, the extinction ratio control circuit of the optical transmitter according to the third embodiment is designed to adjust the RF superimposition level for maintaining the EYE aperture (for preventing the deterioration of the EYE aperture).

As described above, according to the third embodiment, an RF signal with a low frequency is superimposed on a data signal and the amplification degree of the laser drive circuit is controlled on the basis of a level of the RF signal detected by the monitor photodiode to control the extinction ratio of the output light. Accordingly, as well as the effects of the first and second embodiments, even in a case in which the data signal to be transmitted becomes fast, it is possible to control the extinction ratio through the use of a low-priced photodiode generally packaged in a laser module, which eliminates the need for the employment of a high-priced high-response photodiode which can receive fast data. In addition, since the RF superimposition level is adjusted to a level which does not cause the deterioration of the transmission EYE aperture, the characteristic degradation at the 3R regeneration after the transmission is preventable.

(Fourth Embodiment)

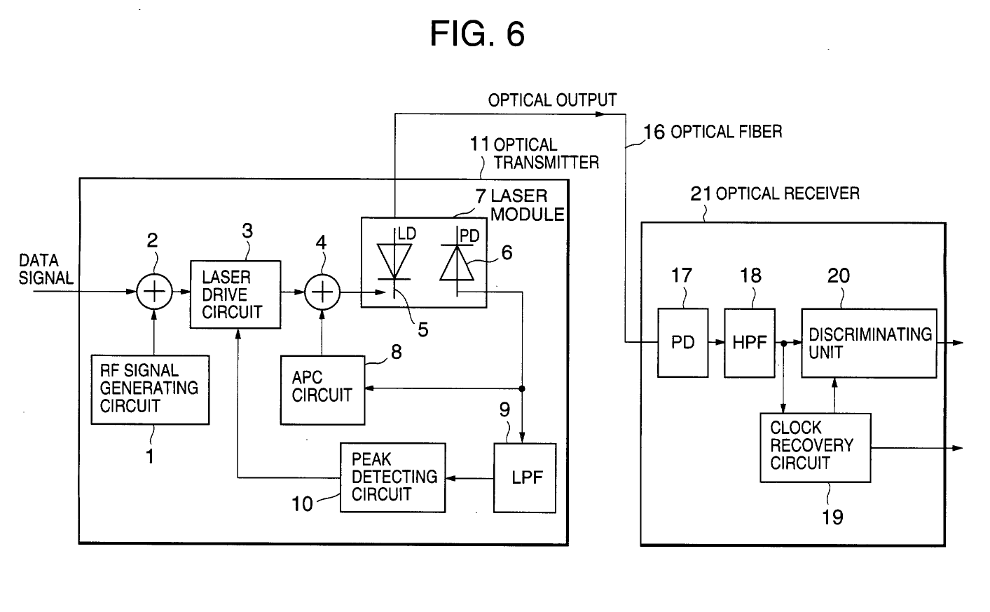

FIG. 6 is a block diagram showing a configuration of an optical transmission system according to a fourth embodiment of the present invention. This optical transmission system uses an optical transmitter according to the first to third embodiments, and as one example, it has a configuration employing the above-described optical transmitter according to the first embodiment as shown in FIG. 1.

As FIG. 6 shows, the optical transmission system according to the fourth embodiment is equipped with, in addition to the optical transmitter 11 according to the first embodiment shown in FIG. 1, an optical receiver 21 which receives an optical signal from the optical transmitter 11 through an optical fiber 16. The optical receiver 21 is made up of a photodiode 17, a high-pass filter (HPF) 18, a clock recovery circuit 19 and a discriminating unit 20, with the HPF 18 being placed at the former stage of the discriminating unit 20 for the regeneration of the data signal to remove a superimposed RF signal from an optical signal.

A description will be given hereinbelow of an operation of the optical transmission system according to the fourth embodiment. The operation of the optical transmitter thereof is the same as that of the first embodiment, and the description thereof will be omitted for brevity.

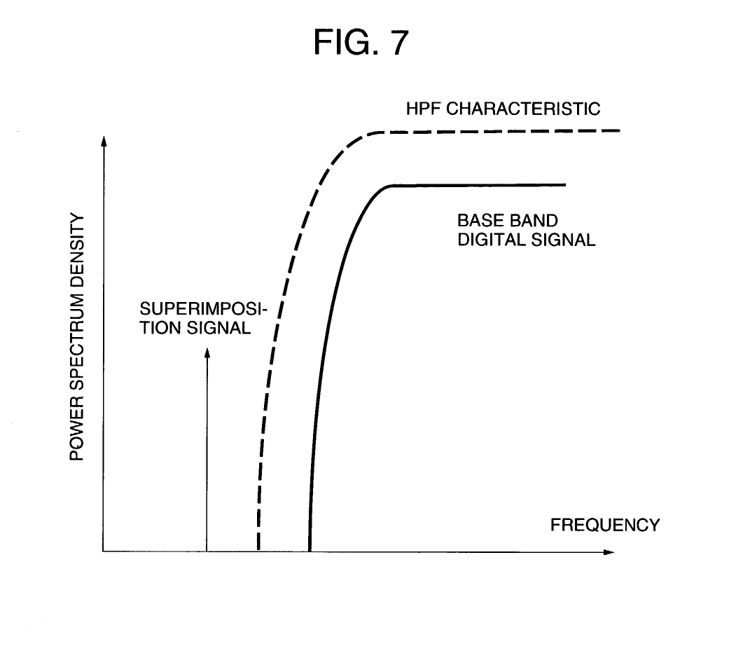

An optical signal received by the optical receiver 21 is photoelectrically converted in the photodiode 17 and fed to the HPF 18. The characteristic of the HPF 18 is shown in FIG. 7. An RF signal is superimposed on the optical signal transmitted, which causes the deterioration of the EYE aperture. The HPF 18 removes the superimposed RF signal, thereby improving the EYE aperture. The data signal after the removal of the RF signal undergoes the clock recovery in the clock recovery circuit 19, and is discriminated and 3R-regenerated in the discriminating unit 20.

As described above, according to the fourth embodiment, in the optical transmitter, an RF signal with a low frequency is superimposed on a digital data signal and the amplification degree of the laser drive circuit is controlled on the basis of the level of the RF signal detected by the monitor photodiode to control the extinction ratio of the output light. Accordingly, even in a case in which the data signal to be transmitted becomes fast, it is possible to control the extinction ratio through the use of a low-priced photodiode generally packaged in a laser module, which eliminates the need for the employment of a high-priced high-response photodiode which can receive fast data. In addition, this arrangement can offer effects similar to those of the first to third embodiments. Still additionally, in the optical receiver, an HPF is provided at the former stage of discriminating unit for the purpose of the removal of an RF signal. This eliminates the deterioration of the EYE aperture stemming from the superimposition of the RF signal in the reception waveform, thus preventing the characteristic degradation at the discrimination and regeneration.

(Fifth Embodiment)

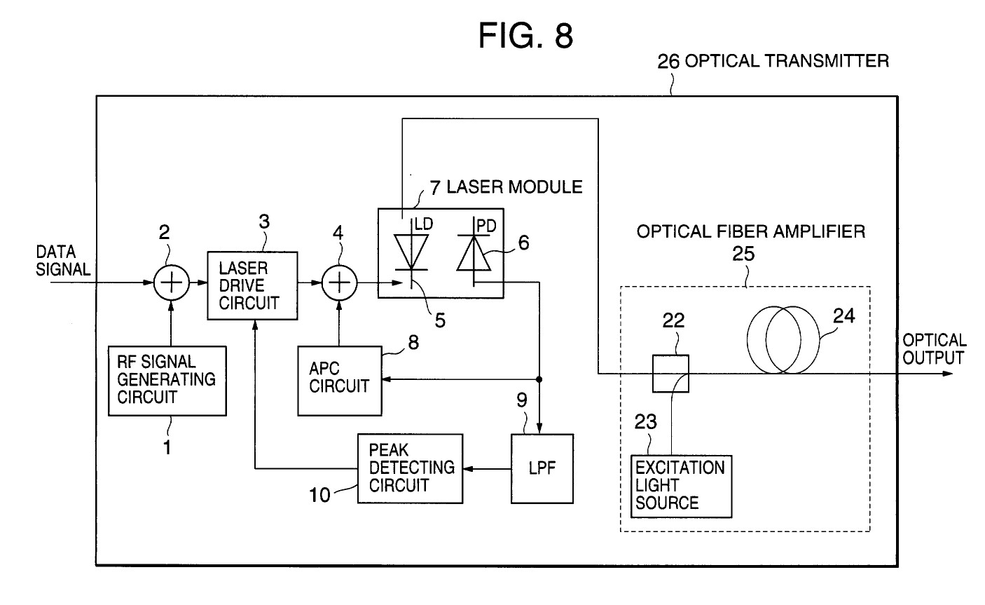

FIG. 8 is a block diagram showing a configuration of an optical transmitter according to a fifth embodiment of the present invention. In FIG. 8, an optical transmitter 26 according to the fifth embodiment includes, in addition to the configuration of the optical transmitter according to the first embodiment shown in FIG. 1, an optical fiber amplifier 25 connected to an optical output terminal of the laser module 7 for leading out an optical output to the external. The optical fiber amplifier 25 is made up of an optical multiplexer 22, an excitation light source 23 and an Erbium-doped optical fiber 24.

Secondly, a description will be given hereinbelow of an operation of the optical transmitter 26 according to the fifth embodiment.

A data signal inputted to the optical transmitter 26 is multiplexed with an RF signal, produced by an RF signal generating circuit 1, in the adding unit 2 and then fed to the laser drive circuit 3 to amplify both the data signal and the RF signal superimposed thereon. A bias current for the laser driving from the APC circuit 8 is added to the data signal and the RF signal, amplified therein, and they are supplied to the laser diode 5. The output of the laser diode 5 is detected by the monitor photodiode 6, and the DC component thereof is given to the APC circuit 8 to control the bias current, to be supplied to the laser diode 5, so that the luminescence quantity from the laser diode 5 becomes constant.

On the other hand, the superimposed RF signal detected by the monitor photodiode 6 is separated from the data signal by the LPF 9. In this case, as FIG. 2 shows, the frequency of the RF signal to be superimposed on the data signal is set to be low enough to separate from the spectrum of the data signal, thus sufficiently reducing the leakage of the spectrum of the data signal into the RF signal. The RF signal separated in the LPF 9 is fed to the peak detecting circuit 10 to detect a peak level thereof so that the amplification degree of the laser drive circuit 3 is controlled to maintain this detection level at a predetermined value, thereby maintaining the extinction ratio of the output of the laser module 7 at a predetermined value.

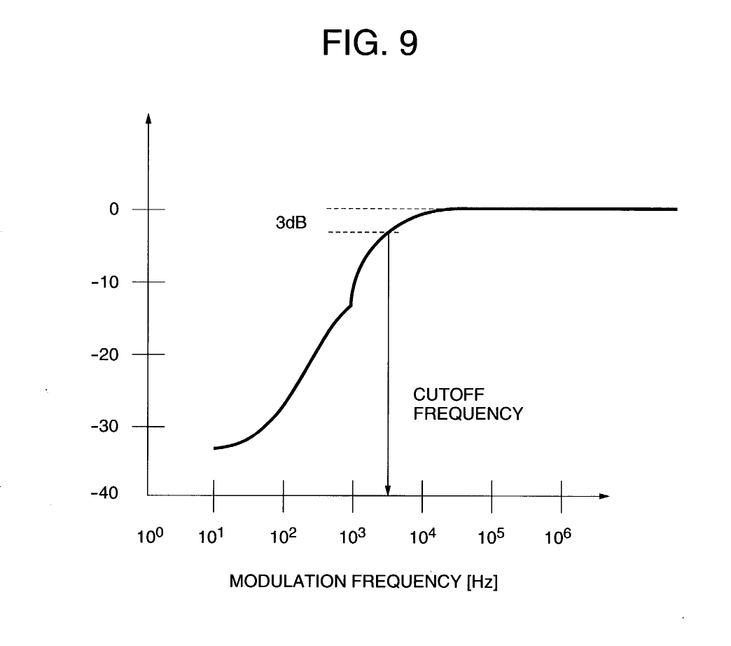

The output light from the laser module 7 subjected to the extinction ratio control passes through the optical fiber amplifier 25. In this case, the frequency response characteristic of the optical fiber amplifier 25 put to use with respect to the modulation frequency has a low-frequency cutoff characteristic as shown in FIG. 9. Accordingly, if the frequency of the RF signal to be superimposed is set to be lower than the cutoff frequency of the optical fiber amplifier 25, when the output light from the laser module 7 passes through the optical fiber amplifier 25, the RF superimposition signal level lowers, that is, the optical fiber amplifier 25 reduces the superimposed RF signal, thereby suppressing the deterioration of the EYE aperture of the output of the optical transmitter 26.

As described above, according to the fifth embodiment, an RF signal with a low frequency is superimposed on a data signal and the amplification degree of the laser drive circuit is controlled on the basis of the level of the RF signal detected by the monitor photodiode to control the extinction ratio of the output light. Accordingly, even in a case in which the data signal to be transmitted becomes fast, it is possible to control the extinction ratio through the use of a low-priced photodiode generally packaged in a laser module, which eliminates the need for the employment of a high-priced high-response photodiode which can receive fast data. In addition, the frequency of the RF signal to be superimposed is set to be low enough to separate from the spectrum of the data signal and, therefore, it is possible to sufficiently reduce the leakage of the spectrum of the digital signal into the RF signal in the output of the monitor photodiode, thus achieving the extinction ratio control with high sensitivity. Still additionally, since the RF signal to be superimposed is put on the data signal at the former stage of the laser drive circuit and then passed through the laser drive circuit, it is possible to prevent the extinction ratio variation of the output light not only due to the temperature variation and aged deterioration of the laser diode but also stemming from the temperature variation and aged deterioration of the laser drive circuit, which enables the control of the extinction ratio to a predetermined value. Yet additionally, since the frequency of the RF signal to be superimposed on the data signal is set to be lower than the cutoff frequency of the optical fiber amplifier, it is possible to prevent the deterioration of the EYE aperture of the optical modulator output and to prevent the characteristic degradation at the discrimination and regeneration after the optical transmission.

(Sixth Embodiment)

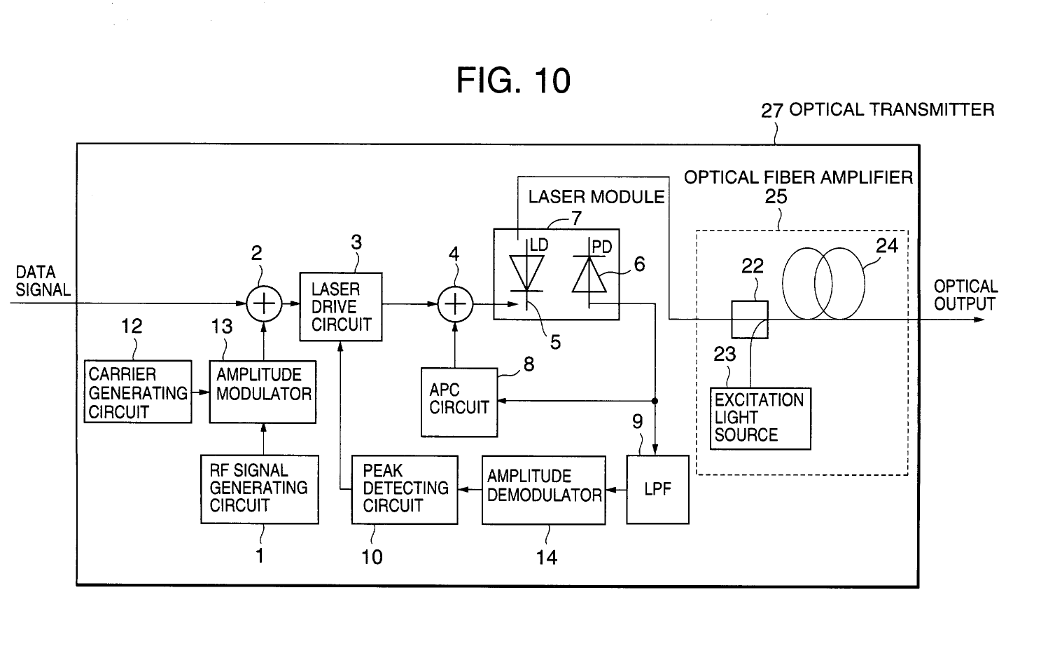

FIG. 10 is a block diagram showing a configuration of an optical transmitter according to a sixth embodiment of the present invention. In FIG. 10, an optical transmitter 27 according to the sixth embodiment includes, in addition to the configuration of the optical transmitter according to the second embodiment shown in FIG. 3, an optical fiber amplifier 25 as in the case of the above-described fifth embodiment.

A description will be given hereinbelow of an operation of the optical transmitter 27 according to the sixth embodiment.

An RF signal produced in the RF signal generating circuit 1 is amplitude-modulated through the use of a carrier signal from the carrier generating circuit 12 in the amplitude modulator 13 and is multiplexed with (superimposed on) a data signal inputted to the optical transmitter 27. This superimposition signal is given to the laser drive circuit 3 to amplify both the data signal and the amplitude-modulated RF signal superimposed thereon. A bias current for laser driving from the APC circuit 8 is applied to the amplified data signal and RF signal and they are supplied to the laser diode 5. The output of the laser diode 5 is detected by the monitor photodiode 6, and the DC component thereof is given to the APC circuit 8 to control the bias current to be supplied to the laser diode 5 so that the laser diode 5 produces a constant luminescence quantity.

On the other hand, the superimposed RF signal detected by the monitor photodiode 6 is separated from the data signal by the LPF 9. The RF signal separated by the LPF 9 is demodulated in the amplitude demodulator 14 and the peak level thereof is detected by the peak detecting circuit 10 so that the amplification degree of the laser drive circuit 3 is controlled to maintain this detection level at a predetermined value, thus maintaining the extinction ratio of the output of the laser module 7 at a predetermined value. Since this arrangement contain a function to amplitude-modulate the RF signal, even in a case in which the leakage of the spectrum of the data signal into the superimposed RF signal occurs slightly as shown in FIG. 4, this arrangement can enhance the strength or resistance against the leakage owing to the amplitude demodulation, thus improving the accuracy of the extinction ratio control

The output light from the laser module 7, undergoing the extinction ratio control, passes through the optical fiber amplifier 25. In this case, the frequency response characteristic of the optical fiber amplifier 25, put to use, with respect to the modulation frequency has a low-frequency cutoff characteristic as shown in FIG. 9. Accordingly, if the frequency of the RF signal to be superimposed is set to be lower than the cutoff frequency of the optical fiber amplifier 25, the RF superimposition signal level passing through the optical fiber amplifier 25 lowers, thereby suppressing the deterioration of the EYE aperture of the output of the optical transmitter 27.

As described above, according to the sixth embodiment, an RF signal with a low frequency is superimposed on a data signal and the amplification degree of the laser drive circuit is controlled on the basis of the level of the RF signal detected by the monitor photodiode to control the extinction ratio of the output light. Accordingly, even in a case in which the data signal to be transmitted becomes fast, it is possible to control the extinction ratio through the use of a low-priced photodiode generally packaged in a laser module, which eliminates the need for the employment of a high-priced high-response photodiode which can receive fast data. In addition, the frequency of the RF signal to be superimposed is set to be low enough to separate from the spectrum of the data signal and, therefore, it is possible to sufficiently reduce the leakage of the spectrum of the digital signal into the RF signal in the output of the monitor photodiode, thus achieving the extinction ratio control with high sensitivity. Still additionally, the employment of the function to amplitude-modulate the RF signal to be superimposed on the data signal improves the resistance against the leakage of the spectrum of the data signal, thus improving the accuracy of the extinction ratio control. Moreover, since the RF signal to be superimposed is put on the data signal at the former stage of the laser drive circuit and then passed through the laser drive circuit, it is possible to prevent the extinction ratio variation of the output light not only due to the temperature variation and aged deterioration of the laser diode but also stemming from the temperature variation and aged deterioration of the laser drive circuit, which enables the control of the extinction ratio to a predetermined value. Still moreover, since the frequency of the RF signal to be superimposed on the data signal is set to be lower than the cutoff frequency of the optical fiber amplifier, it is possible to prevent the deterioration of the EYE aperture of the optical modulator output and to prevent the characteristic degradation at the discrimination and regeneration after the optical transmission.

(Seventh Embodiment)

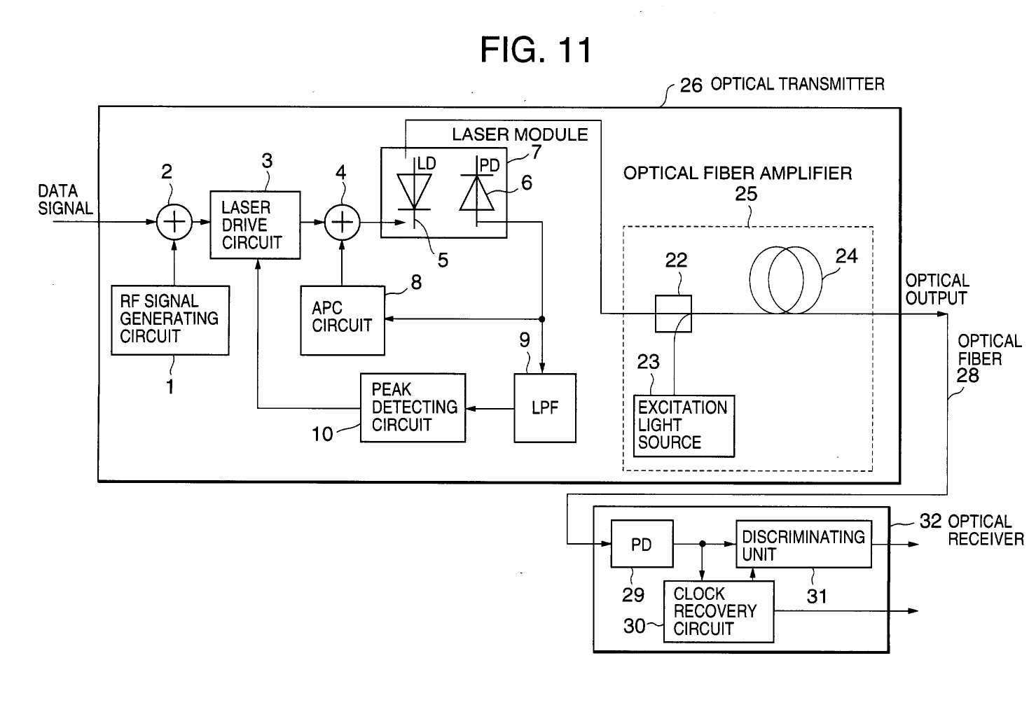

FIG. 11 is a block diagram showing a configuration of an optical transmission system according to a seventh embodiment of the present invention. This optical transmission system employs the optical transmitter according to the fifth or sixth embodiment, and as one example, has a configuration using the optical transmitter according to the fifth embodiment as shown in FIG. 11. The optical transmission system according to the seventh embodiment shown in FIG. 11 includes, in addition to the optical transmitter 26 according to the fifth embodiment shown in FIG. 8, an optical receiver 32 for receiving an optical signal from the optical transmitter 26 through an optical fiber 28. The optical receiver 32 is composed of a photodiode 29, a clock recovery circuit 30 and a discriminating unit 31.

A description will be given hereinbelow of an operation of the optical transmission system according to the seventh embodiment. The operation of the optical transmitter 26 is similar to that according to the fifth embodiment, and the description thereof will be omitted for simplicity.

An optical signal received by the optical receiver 32 is photoelectrically converted in the photodiode 29 and is subjected to clock recovery in the clock recovery circuit 30 and further is discriminated in the discriminating unit 31 for the 3R regeneration. In this optical transmission system, the modulation level of the superimposed RF signal of the output of the laser module 7 is lowered to prevent the deterioration of the EYE aperture of the transmission signal, and without placing an HPF for the removal of an RF signal on the receiver side, the characteristic degradation at the discrimination/regeneration after the transmission is preventable.

As described above, according to the seventh embodiment, in the optical transmitter, an RF signal with a low frequency is superimposed on a data signal and the amplification degree of the laser drive circuit is controlled on the basis of the level of the RF signal detected by the monitor photodiode to control the extinction ratio of the output light. Accordingly, even in a case in which the data signal to be transmitted becomes fast, it is possible to control the extinction ratio through the use of a low-priced photodiode generally packaged in a laser module, which eliminates the need for the employment of a high-priced high-response photodiode which can receive fast data. In addition, this offers effects similar to those of the fifth and sixth embodiment. Still additionally, since the data signal received by the optical receiver has a reduced RF signal level owing to the optical amplifier, the characteristic degradation at the discrimination and regeneration is preventable.

It should be understood that the present invention is not limited to the above-described embodiments, and that it is intended to cover all changes and modifications of the embodiments of the invention herein which do not constitute departures from the spirit and scope of the invention.

What is claimed is:

1. An optical transmitter comprising:
a laser module including a laser diode for issuing an optical output and a monitor photodiode for monitoring said optical output from said laser diode;
a laser drive circuit for supplying a drive current to said laser module;
an automatic output control circuit for supplying a bias current to said laser module on the basis of a detection signal from said monitor photodiode so that said laser module produces a constant output level; and
an extinction ratio control circuit for superimposing an RF signal on an input data signal to said laser drive circuit to control an amplification degree of said laser drive circuit on the basis of the superimposed RF signal of said detection signal from said monitor photodiode so that an output light of said laser module has a constant extinction ratio.

2. The optical transmitter according to claim 1, wherein said extinction ratio control circuit uses, as said RF signal to be superimposed on said data signal, an RF signal having a low frequency which does not overlap with a spectrum of said data signal, and said laser drive circuit has a low-frequency amplification function to make an amplification in a range from a low frequency, covering the superimposed low-frequency RF signal.

3. The optical transmitter according to claim 1, wherein said extinction ratio control circuit uses, as said RF signal to be superimposed on said data signal, a signal amplitude-modulated, and amplitude-demodulates, of said detection signal from said monitor photodiode, the amplitude-modulated RF signal to control an amplification degree of said laser drive circuit on the basis of the demodulated signal so that an output light of said laser module has a constant extinction ratio.

4. The optical transmitter according to claim 3, wherein said extinction ratio control circuit uses, as the amplitude-modulated RF signal to be superimposed on said data signal, an amplitude-modulated RF signal with a low frequency enough to avoid complete burying in a spectrum of said data signal, and said laser drive circuit has a low-frequency amplification function to make an amplification in a range from a low frequency, covering the amplitude-modulated low-frequency RF signal to be superimposed thereon.

5. The optical transmitter according to claim 1, wherein said extinction ratio control circuit uses, as said RF signal to be superimposed on said data signal, an RF signal with a level low enough to avoid a degradation of an EYE aperture of an output light from said laser module due to the superimposition of said RF signal.

6. An optical transmission system comprising an optical transmitter and an optical receiver made to receive an optical signal from said optical transmitter,
said optical transmitter including:
a laser module composed of a laser diode for issuing an optical output and a monitor photodiode for monitoring said optical output from said laser diode;
a laser drive circuit for supplying a drive current to said laser module;
an automatic output control circuit for supplying a bias current to said laser module on the basis of a detection signal from said monitor photodiode so that said laser module produces a constant output level; and
an extinction ratio control circuit for superimposing an RF signal on an input data signal to said laser drive circuit to control an amplification degree of said laser drive circuit on the basis of the superimposed RF signal of said detection signal from said monitor photodiode so that an output light of said laser module has a constant extinction ratio, and
said optical receiver including a high-pass filter located at the former stage of a discriminating unit, which is for regenerating a data signal, for removing the superimposed RF signal from said optical signal.

7. The optical transmitter according to claim 1, further comprising an optical fiber amplifier connected to an optical output terminal of said laser module for leading out said optical output from said laser module, said extinction ratio control circuit using, as said RF signal to be superimposed on said input data signal to said laser drive circuit, an RF signal with a low frequency lower than a low cutoff frequency of said optical fiber amplifier and supplies said data signal and the superimposed RF signal to said laser drive circuit for controlling the amplification degree of said laser drive circuit on the basis of the superimposed RF signal of said detection signal from said monitor photodiode so that an output light of said laser module has a constant extinction ratio.

8. The optical transmitter according to claim 7, wherein said extinction ratio control circuit uses, as said RF signal to be superimposed on said data signal, an RF signal with a low frequency lower than a low cutoff frequency of said optical fiber amplifier and enough to avoid overlapping with a spectrum of said data signal, and said laser drive circuit has a low-frequency amplification function to make an amplification in a range from a low frequency, covering said low-frequency RF signal to be superimposed thereon.

9. The optical transmitter according to claim 7, wherein said extinction ratio control circuit uses, as said RF signal to be superimposed on said data signal, a signal amplitude-modulated, and amplitude-demodulates, of said detection signal from said monitor photodiode, the amplitude-modulated RF signal to control the amplification degree of said laser drive circuit on the basis of the demodulated signal so that an output light from said laser module has a constant extinction ratio.

10. The optical transmitter according to claim 9, wherein said extinction ratio control circuit uses, as the amplitude-modulated RF signal to be superimposed on said data signal, an amplitude-modulated RF signal with a low frequency lower than a low cutoff frequency of said optical fiber amplifier and enough to avoid complete burying in a spectrum of said data signal, and said laser drive circuit has a low-frequency amplification function to make an amplification in a range from a low frequency, covering the amplitude-modulated low-frequency RF signal to be superimposed thereon.

11. An optical transmission system comprising an optical transmitter and an optical receiver made to receive an optical signal from said optical transmitter,
said optical transmitter including:
a laser module including a laser diode for issuing an optical output and a monitor photodiode for monitoring said optical output from said laser diode;
a laser drive circuit for supplying a drive current to said laser module;
an automatic output control circuit for supplying a bias current to said laser module on the basis of a detection signal from said monitor photodiode so that said laser module produces a constant output level;
an extinction ratio control circuit for superimposing an RF signal on an input data signal to said laser drive circuit to control an amplification degree of said laser drive circuit on the basis of the superimposed RF signal of said detection signal from said monitor photodiode so that an output light of said laser module has a constant extinction ratio; and
an optical fiber amplifier connected to an optical output terminal of said laser module for leading out said optical output from said laser module,
said extinction ratio control circuit using, as said RF signal to be superimposed on said input data signal to said laser drive circuit, an RF signal with a low frequency lower than a low cutoff frequency of said optical fiber amplifier and supplies said data signal and the superimposed RF signal to said laser drive circuit for controlling the amplification degree of said laser drive circuit on the basis of the superimposed RF signal of said detection signal from said monitor photodiode so that an output light of said laser module has a constant extinction ratio.
